(19) United States
(12) Patent Application Publication
(10) Pub. No.: US 2017/0262869 A1
(43) Pub. Date: Sep. 14, 2017

(54) MEASURING SOCIAL MEDIA IMPACT FOR BRANDS

(71) Applicant: International Business Machines Corporation, Armonk, NY (US)

(72) Inventors: Fatemeh JALALI, Hawthorn East (AU); Xi LIANG, Ormond (AU); Benjamin Scott MASHFORD, Malvern East (AU); Shaila PERVIN, Docklands (AU); Wanita SHERCHAN, Clayton South (AU)

(21) Appl. No.: 15/066,076

(22) Filed: Mar. 10, 2016

(51) Int. Cl. G06Q 30/02; G06F 17/30; G06K 9/46; G06Q 50/00

(52) U.S. Cl. CPC G06Q 30/0201; G06Q 50/01; G06F 17/30864; G06K 9/4671

(57) ABSTRACT

To evaluate impact to a brand on social media, a computer is used to crawl through social media postings of social media services to select postings relating to one or more sponsored events. The selected postings are analyzed by computer to quantify keywords relating to particular brands. Images posted within the selected postings are also analyzed, using a pattern matching algorithm, to quantify depictions of the one or more brands within the images.

### BACKGROUND OF THE DISCLOSURE

Sponsors can access demographic data recorded by contact with attendees at booths, sales figures, and leads generated, as provided by previous sponsors. A computer can process historical data for an event and estimate the reach of an onscreen advertisement using known algorithms.

Determining brand exposure in video streams intended for broadcast is carried out by comparing a reference mask correlating to a trademark with video frames in the video stream.

Sponsors may place advertising with social publishers, the ads visible on the website page together with social content.

### SUMMARY OF THE DISCLOSURE

In an embodiment of the disclosure, a method comprises using one or more processors executing software stored on computer readable storage medium to crawl through social media postings of one or more social media services to select postings relating to one or more sponsored events; analyze text posted within the selected postings to quantify keywords relating to one or more brands; and analyze images posted within the selected postings to quantify, using a pattern matching algorithm, depiction of the one or more brands within the images.

In another embodiment of the disclosure, a computer program product for evaluating an impact to a brand comprises a computer readable storage medium having program instructions, embodied therewith, the program instructions executable by one or more processors to cause the one or more processors to: crawl through social media postings of one or more social media services to select postings relating to one or more sponsored events; analyze text posted within the selected postings to quantify keywords relating to one or more brands; and analyze images posted within the selected postings to quantify, using a pattern matching algorithm, depiction of the one or more brands within the images.

In a further embodiment of the disclosure, a method for evaluating impact to a brand on social media comprises using one or more processors executing software stored on computer readable storage medium to: crawl through social media postings of one or more social media services to select social media user postings relating to one or more sponsored events using a predetermined list of events; separate text, audio, video, and image data from the selected postings; filter the separated data by one or more brands using a predetermined list of brands, by analyzing text to identify keywords within the separated data relating to one or more brands, and by analyzing images or video frames within the separated data to identify depictions of the one or more brands within the images; and determine the social media impact of the one or more sponsored events by measuring an extent of the identified keywords and depictions in the social media postings relating to the one or more sponsored events.

### BRIEF DESCRIPTION OF THE DRAWINGS

FIG. 1 depicts incidental brand presentation within an image within a social media posting;

FIG. 2 depicts incidental brand presentation within a video within a social media posting;

FIG. 3 depicts a system of the disclosure for identifying incidental brand presentations within various types of content within social media postings relating to one or more events;

FIG. 4 depicts a screen display of a trade-off analysis program applying differing weights to various social media services, based upon identification of explicit and incidental brand presentations identified by the system of FIG. 3;

FIG. 5 is a flow chart depicting a method of the disclosure;

FIG. 6 depicts a cloud computing environment according to an embodiment of the present invention;

FIG. 7 depicts abstraction model layers according to an embodiment of the present invention; and

FIG. 8 depicts a computer system, parts or all of which can be used to carry out the disclosure.

### DETAILED DESCRIPTION OF THE DISCLOSURE

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The disclosure provides a system and method for electronic cognitive assistance for sponsorship decisions based upon the social media impact of brands in events. In particular, the disclosure measures the effectiveness of sponsoring an event, including the measurement of the Social Media Impact (SMI) of sponsoring an event, which can be used when making decisions regarding future event sponsorship.

Herein, the term ‘brand’ is used to indicate any of a product brand, trademark, tradename, service mark, certification mark, collective mark, or any name or symbol whose presentation and use is of interest. In one aspect of the disclosure, text based analytics are used to measure specific mentions of a brand or other subject of interest, by crawling, or searching through large or vast quantities of data using electronic processors included in an electronic system 100 of the disclosure, in this context through social media posts which are obtainable or accessible. In another aspect of the disclosure, the presence of brands within visual media posted in social media posts relating to specific sponsored events are analyzed and quantified, together with other aspects of the posting.

The disclosure provides examples of social media services or social networking services, including TWITTER, FACEBOOK, INSTAGRAM, YOUTUBE, and news feeds. As described in the Wikipedia entry for social media, there are many more such services, sites, apps, or portals, and more continue to be formed. Thus the social media services referenced herein, while currently popular, are examples only, and may be augmented or substituted by other social media services. The disclosure is intended to be used with all such sites, which are characterized by enabling users to actively contribute content which can be accessed by a wide audience, and particularly by the public. The content may include one or more of text, images, videos, apps, or other types of content not yet conceived. The content is typically uploaded as TWEETS or Re-Tweets, blog posts, video uploads, comments, links, or other content found within the Cloud. Herein, the term ‘post’ or ‘posting’ refers to any discrete contribution to social media.

Social media is commonly available to the public at little to no cost, which facilitates a reach to a very wide audience. Social media content is often published immediately after it is contributed, and can often be edited or removed thereafter. Social media enables co-creation of products and services between the corporation and the consumer in a unique way.

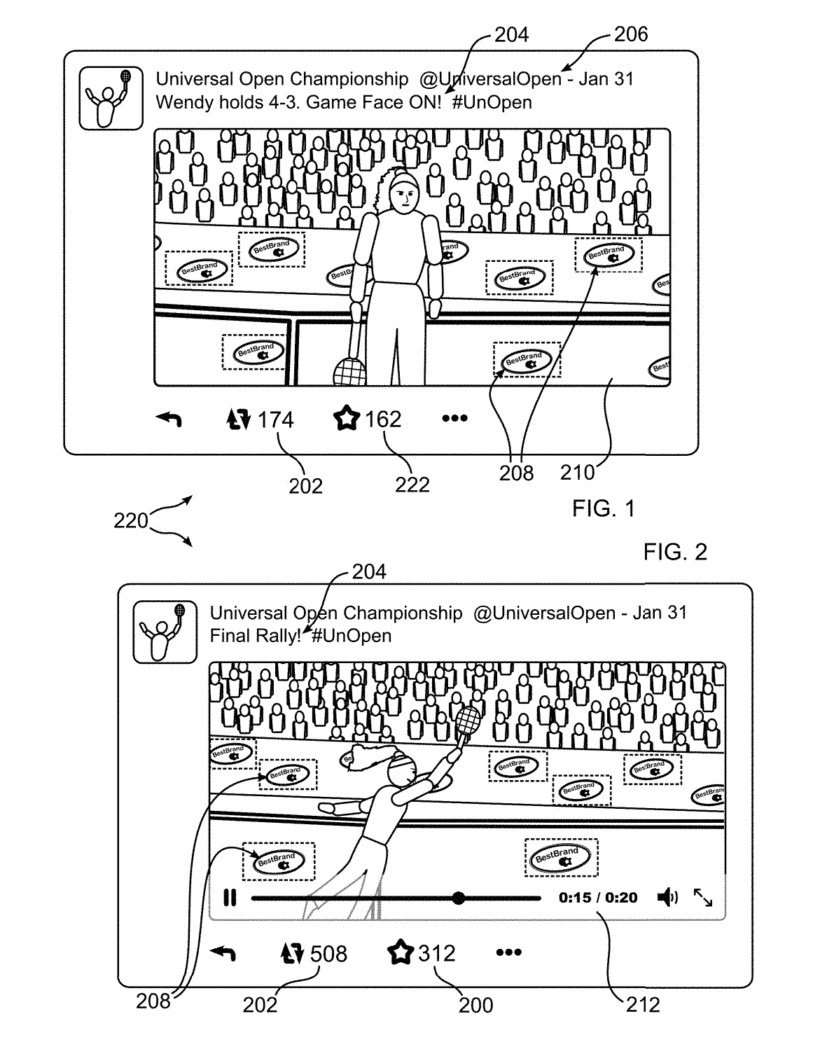

As can be seen in the example social media post of FIG. 1, in this example a Twitter post, text values are obtainable from the Twitter API (Application Programming Interface). Many social media apps, outlets, sites, or services (hereinafter simply ‘services’) provide such an API so that computers can browse the posted content, and otherwise interact with computer systems of the service. The API can provide the ability to search for posts 220 relating to specified criteria, and can provide text data for the subset including values such as the number of favorites or likes (222) and the number of shares or Re-Tweets (202), number of brand mentions within the text of the message (204), and other criteria which can be specified. The content accessed through the API is either publicly available, or the accessing computer has login credentials to access the content.

In the notional examples of FIGS. 1 and 2, the brand “BestBrand” has been a sponsor of the “Universal Open Championship” event for one or more events. Social media conversations related to BestBrand in the context of the Universal Open are identifiable by their official hashtag #bestbrand. However, in the examples of FIGS. 1 and 2, posts are associated with the hashtag #UnOpen, which correspond to the ‘Universal Open Championship’ @UniversalOpen (206). However, while BestBrand is not mentioned in the text or an associated hashtag, the BestBrand brand is nonetheless associated with the posts, within the image or video. The disclosure provides a method for identifying such posts, which provide additional publicity for BestBrand. In FIGS. 1 and 2, the BestBrand logo (208) is present in media within the post, including within image 210 (FIG. 1) and video 212 (FIG. 2). These instances are highlighted by a dashed bounding box in the Figures.

While neither of the Twitter posts mention #bestbrand in the tweet text itself, both of them nonetheless have significant social media impact for the BestBrand brand at the Universal Open event, as the brand logo is presented in the shared posts. The disclosure enables identifying these incidental appearances of a brand in order to reveal an otherwise hidden social media impact of a brand present in all types of data in addition to text, such as image, video and audio content that doesn't otherwise signal an appearance of the brand of interest.

In addition to identifying instances of a brand, where sufficient post data is available, system 100 can derive a count of instances of an appearance of the brand, a count of the number of times a posting containing an instance has been viewed, and an amount of time each instance within the post is exposed, for example total time that instances within a video are on-frame. System 100 can further determine a sentiment of the post using the textual content or context of the post. Sentiment within the text can be determined by examining keywords and phrases, and comparing them with a lookup database indicating whether the terms reflect a favorable or unfavorable viewpoint of the brand. This can be categorized, for example, as a particular degree of positive, neutral, or negative sentiment.

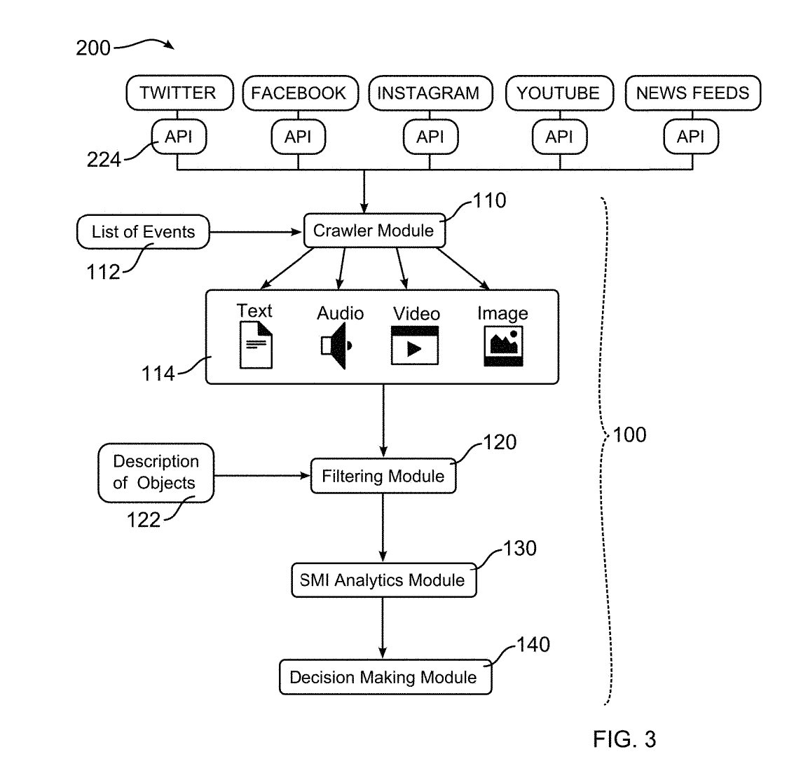

With reference to FIG. 3, system 100 includes a plurality of modules which accomplish the foregoing analysis. Social media content 200 is diagrammed at the top of FIG. 3. It should be understood that these represent popular social media services, and that there could be any number of social media inputs. Each social media service can include an API 224 which can be accessed by system 100 to gather data from its respective social media service. It should be understood that data from a particular social media service may be available by other means than an API, for example by download or screen scraping, and that system 100 can use such alternative data sources.

Herein, the term Module relates to software of system 100 that executes upon an electronic processor and which is targeted to a particular task, as described herein. A given module can include software that is only executed in carrying out the particular task, as well as software shared with other modules.

System 100 includes a crawler module 110 which queries the various APIs, examines the source content obtained from each respective social media service, and filters them by event. Crawler module 110 is provided with a list of events 112, which can be generated by a marketing investigator, for example, or can be derived by system 100 by searching the internet for one or more brands of interest. The list of events can contain a single event of interest, or numerous events. Crawler module can collect event related data from any number of services, including the example services illustrated in FIG. 3, which include Facebook, Twitter, Instagram, YouTube, and news channels, using their associated APIs.

Once the material has been downloaded from the social media service, crawler module 110 or other software of system 100 organizes them by type (at 114), including the types of text, audio, video, and images. These represent the most popular types, however other content types can be analyzed, as currently exist or are hereinafter created.

To select only for the presence of a target brand in relation to posts relating to a particular event, typically an event sponsored by the brand, the API could be queried for dedicated event based social media accounts, for example @UniversalOpen; random posts from anyone mentioning the event based hashtags, for example #UnOpen; or posts which are tagged with keywords relating to the event.

Once the crawler has collected and organized the posts which are potentially of interest, a filtering module 120 analyzes the posts, examining for target objects based upon a description of objects 122. The target objects can include any or all of brand names as text, either within images/video within a post, or within the post itself, brand names or logos as vector or bitmap graphics, sounds, tunes, music, jingles, video clips, or any other type of object that is used to signify a brand. The objects in the description of objects can correspond to a single brand, or more than one brand. The filtering module stores a count of the number of incidences of a target object within any portion of the post, and the duration of appearance of such targets if they are within a video or audio file, whether streaming or downloaded. The filtering module can additionally analyze a location of the objects, as described further below.

If filtering module 120 is filtering text, it can include text available in a particular type of post. For example, the Twitter text of up to 140 characters in Tweets; image captions of Instagram images; and video descriptions of YouTube videos. Assuming the posts have already been filtered for relating to the event of interest, the text is next searched for the brand or event related hashtags for the brand, for example Best Brand or #bestbrand. If they exist, the post is considered related to the brand for that event.

If filtering module 120 is filtering images, the image is scanned for the presence of the brand, for example using a reference mask, in search of a printed name or logo, using object recognition techniques currently known or herein after created. If an event related image contains the brand of a sponsor inside the image, then the associated post is filtered as relevant to the brand for that event.

If filtering module 120 is filtering video, then the audio portion of the video can be scanned for sounds relating to the brand, such as jingles, or trademarked sounds. Images of the brand can be recognized as when filtering images, by analyzing some or all of the frames from the video as independent images. The time corresponding to a frame when an image first appears, and when the image stops appearing, can be noted to track the duration of the brand exposure. This analysis can be carried out for each instance of the brand present within the video, if more than one instance of the brand appears at the same time, as shown in FIGS. 1-2.

The filtering module 120 thus filters all retrieved posts for instances of the brand in all forms in which it may be present within a post, and generates data which can be analyzed. More particularly, a social media impact analytics module 130 calculates a Social Media Impact (SMI) of the event for brands of interest. In an embodiment, SMI is based on three factors: Exposure, Influence, and Engagement, which are illustrated in Table 1, for popular social media services.

TABLE 1
Criteria Useable in Measuring Social Media Impact

| SMI | Twitter | Facebook | YouTube | Instagram | News |
|---|---|---|---|---|---|
| Exposure | # of tweets | # of posts | # of videos | # of images | # of articles |
| | # of people | # of people | # of unit time | # of people | |
| | tweeting | posting | showing a | posting | |
| | | | brand logo | | |
| Influence | # of positive | # of positive posts | # of positive | # of positive | # of positive |
| | tweets | # of positive | video | image captions | posts |
| | | comments | descriptions | # of positive | # of positive |
| | | | # of positive | comments | comments |
| | | | comments | | |
| Engagement | # of favorites | # of likes | # of views | # of favorites | # of views |
| | # of retweets | # of shares | # of likes | # of comments | # of likes |
| | | # of comments | # of comments | | # of comments |
| | | | # of shares | | # of shares |

It may be seen that exposure is a measurement of quantity of appearances of the brand, influence measures a quantity of expressed positive opinions relating to the brand, and engagement measures a quantity of other forms of affirmation of positive opinion or interest.

The filtering module can be used to store not only a count of the incidences of appearance of the target object within an image or video, as described above, but also a physical real world location of those incidences. Images and videos frequently contain meta data which can include a GPS or other coordinate location, or encoded information provided by the user, which can be correlated with the target objects found within the image or video frame.

Still further, object recognition can be used to identify a particular wall, structure, or other precise location in which a target object was identified, by comparing the image or video frame with reference images of target locations of interest, for example walls or other structures which display brands. The identification of such target locations can be provided by the event organizer, marketing specialists, or advertisers, for example.

The information thus obtained can be used by event organizers to set prices for displaying and positioning brands at various physical locations or positions within the event venue. Pricing can reflect, for example, the number of times one or more brands were presented within posted content for a particular physical location. Further, a relative popularity of particular locations as spots for photographs or videos can be better understood, and this information can be exploited for further brand presentation, and can provide additional value to advertisers and event organizers. The location data can be provided at a level of granularity reflecting the precision of the location data that is available within the metadata, or that may be obtained by object recognition.

System 100 can additionally include a decision making module 140 which facilitates a decision as to whether sponsoring a particular event with respect to a brand has produced results meriting further sponsorship. Decision making module uses the data obtained from filtering module 120 and the SMI analytics module 130 to apply trade-off analytics, for example using the IBM Watson Develop Cloud, to weigh and balance the relative impact relating to sponsoring various events. System 100 can provide the capability to visualize the varying Social Media Impact preferences in different media channels, and to observe the performance of different brands in different events, again using, for example, Watson, although other systems can be used. The decision making module provides the capability to change preferences of Social Media Impact in different channels, and to decide which event and what sponsorship type best suited the preference that was specified in historically available data.

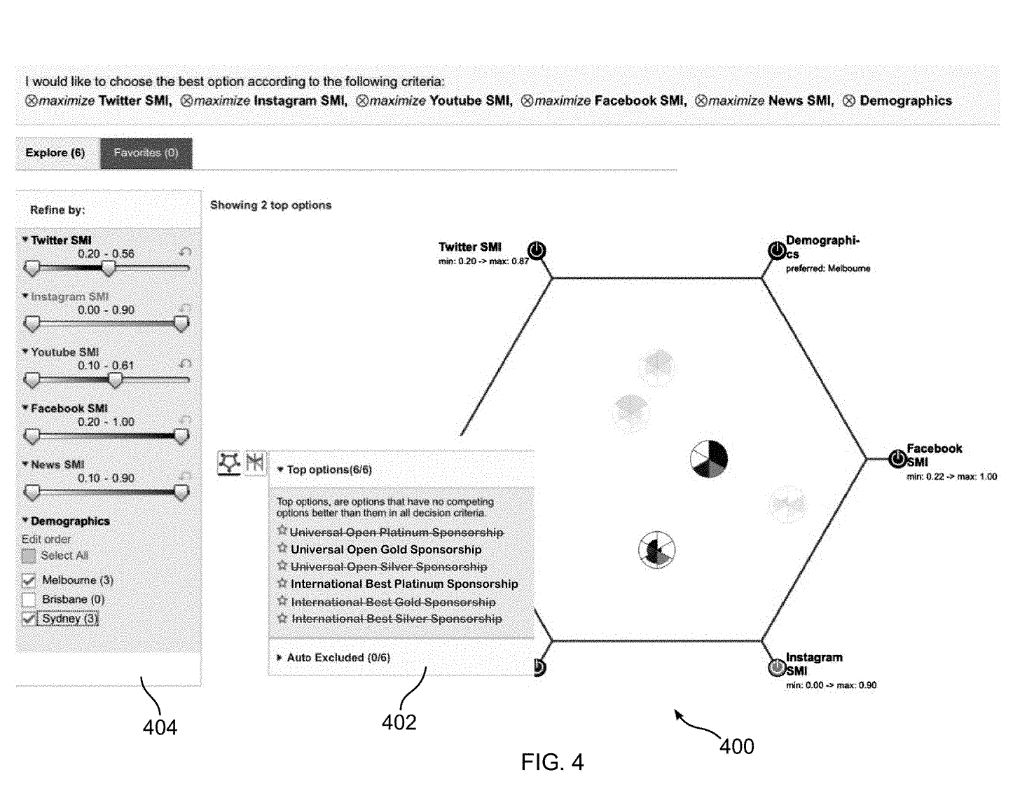

An example is shown in FIG. 4, in which Tradeoff Analytics 400 determined, as shown in panel 402, that the Universal Open Gold Sponsorship and the International Best Platinum Sponsorship matched a specified sponsorship performance criteria, based upon historical performance as determined using the data provided as output of the filtering model 120 and the SMI analytics model 130. As may be seen in FIG. 4, weighting can be changed in panel 404 for data pertaining to various social media services, indicating their relative importance with respect to performance goals for sponsorship.

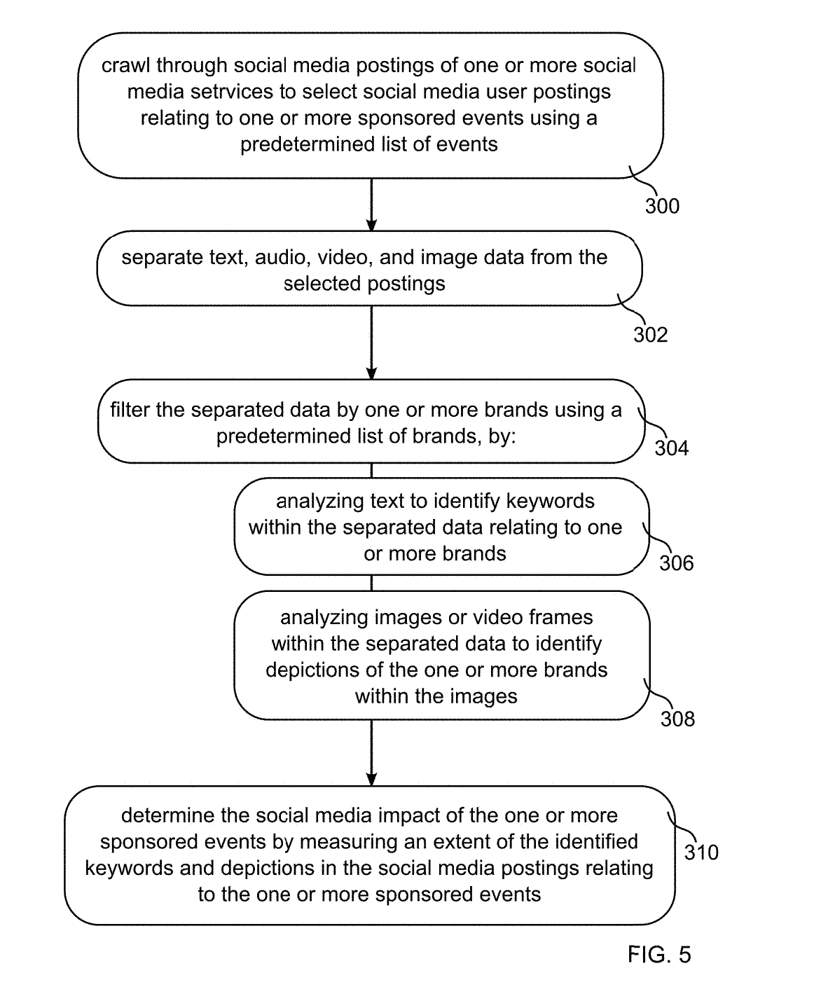

A method of the disclosure is illustrated in FIG. 5, in which a crawler software module of system 100 crawls through social media postings of one or more social media services to select social media user postings relating to one or more sponsored events using a predetermined list of events (300), and separates text, audio, video, and image data from the selected postings (302). A filtering module of system 100 filters the separated data by one or more brands using a predetermined list of brands (304), by analyzing text to identify keywords within the separated data relating to one or more brands (306), and by analyzing images or video frames within the separated data to identify depictions of the one or more brands within the images (308). An SMI Analytics module of system 100 determines the social media impact of the one or more sponsored events by measuring an extent of the identified keywords and depictions in the social media postings relating to the one or more sponsored events (310). A decision making module, not depicted in FIG. 5, can be provided as part of system 100, or can be provided in a Cloud or Internet based service, as described elsewhere herein.

By identifying explicit and incidental occurrences of a brand of interest within posts of various social media services, the disclosure provides a single platform for marketing professionals to visualize the combined and comparative analysis of the historical social media impact of different brands in different events, which facilitates a decision regarding a selection of events to sponsor, and what sponsorship types to choose, for future marketing or public relations efforts.

The disclosure thus considers the social media impact of the sponsoring brands in the participating events, including how many times and with what type of sentiment the sponsoring brand is mentioned in the social media posts related to that event, by evaluating how many times the sponsoring brand is present in the event images and videos shared in social media.

The disclosure considers social media impact across digital media channels, and enables selection of an event to sponsor based on the social media impact of the event, based on results of past sponsorship of the event. Social media impact includes volume and reach of social conversation; the quality of conversation including influence (positive/negative) of the sponsoring brand on the social media users; and the publicity/spread of the brand in the various multimedia shared within the social media services.

By considering the social media impact of the sponsoring brands in the participating events, for example the number of times and with what type of sentiment the sponsoring brand is mentioned in the social media posts related to that event, advertisers can compare the relative overall impact for several events. Concomitantly, the disclosure enables filtering for the social media impact to specific brands at particular events.

The disclosure enables measuring the social media impact of sponsoring an event by evaluating not only the social media profile of the event itself, but also evaluates the values of different brands present in social media posts related to that event.

By analyzing incidental, unintended, or otherwise non-sponsored representations of a brand within social media posts, the disclosure enables discovery of a formerly hidden value of sponsoring a brand in an event. These non-sponsored representations can be combined with data pertaining to intended sponsored representations to obtain a more complete view of the brand representation connected with an event.

Additionally, the disclosure generates a more complete dataset for use in a platform which combines social media content and other marketing data for use by marketing professionals to do comparative analysis of social media impact of different brands in different past events, and to make more informed decisions regarding which events to sponsor in the future. The decision making interface provides a detailed view of the SMI metrics by event as well as by social media source. This allows the marketing professional to get a deeper insight regarding, for example, which demographics (geographical area and personality types) the brand has a positive influence on, and which demographics need to be better targeted.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

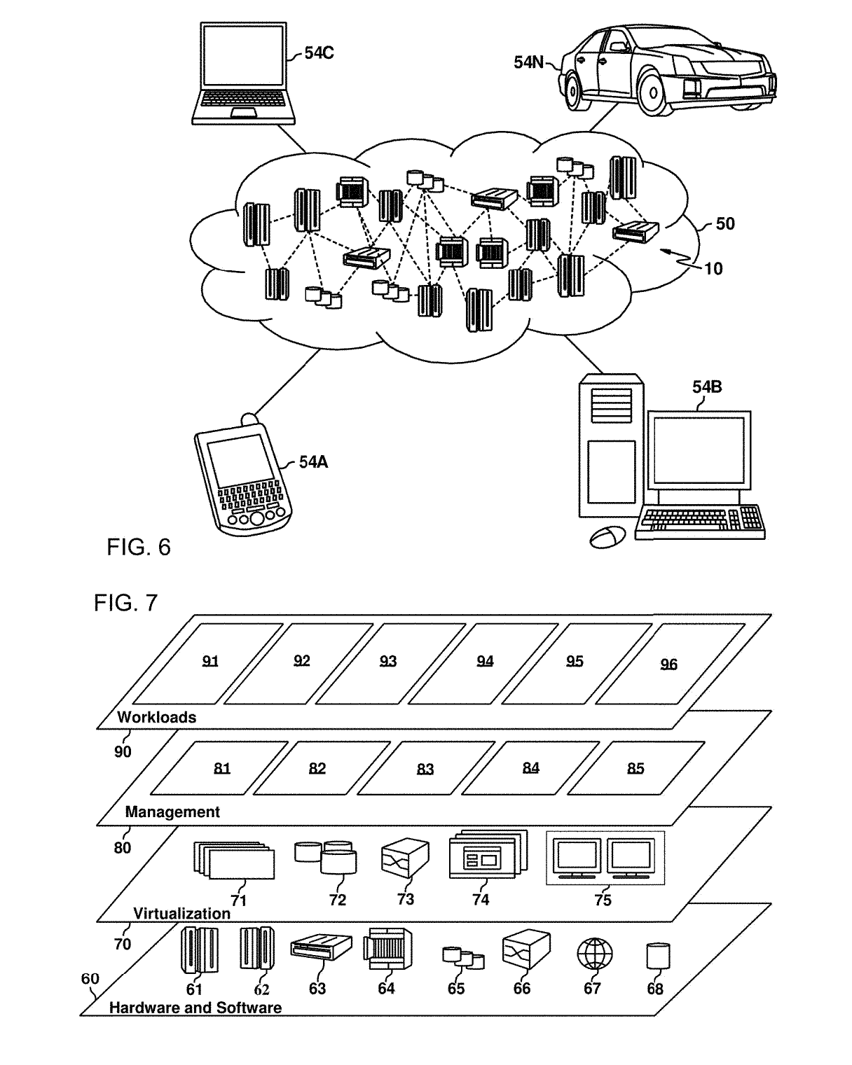

Referring now to FIG. 6, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided: Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and trade-off analytics 96. It should be understood that either or both of system 100 and trade-off analytics can be implemented in either or both of a local computing environment or in the cloud. When implemented in the cloud, they may have components in any or all of layers 60, 70, 80, and 90.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagram in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

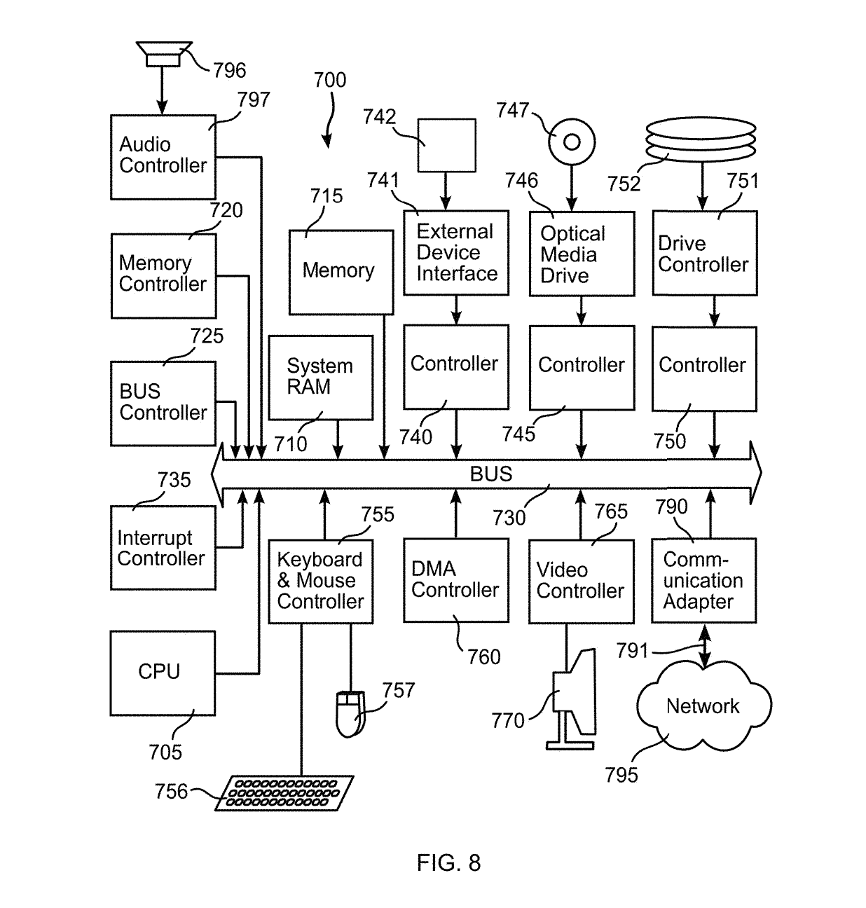

FIG. 8 illustrates the system architecture for a computer system 700 on which or with which the disclosure may be implemented. The exemplary computer system of FIG. 8 is for descriptive purposes only. Although the description may refer to terms commonly used in describing particular computer systems, the description and concepts equally apply to other systems, including systems having architectures dissimilar to FIG. 8. One or more sensors, not shown, provide input to computer system 700, which executes software stored on non-volatile memory, the software configured to received inputs from sensors or from human interface devices, in calculations for controlling system 200.

Computer system 700 includes at least one central processing unit (CPU) 705, or server, which may be implemented with a conventional microprocessor, a random access memory (RAM) 710 for temporary storage of information, and a read only memory (ROM) 715 for permanent storage of information. A memory controller 720 is provided for controlling RAM 710.

A bus 730 interconnects the components of computer system 700. A bus controller 725 is provided for controlling bus 730. An interrupt controller 735 is used for receiving and processing various interrupt signals from the system components.

Mass storage may be provided by DVD ROM 747, or flash or rotating hard disk drive 752, for example. Data and software, including software 400 of the disclosure, may be exchanged with computer system 700 via removable media such as diskette, CD ROM, DVD, Blu Ray, or other optical media 747 connectable to an Optical Media Drive 746 and Controller 745. Alternatively, other media, including for example a media stick, for example a solid state USB drive, may be connected to an External Device Interface 741, and Controller 740. Additionally, another computing device can be connected to computer system 700 through External Device Interface 741, for example by a USB connector, BLUETOOTH connector, Infrared, or WiFi connector, although other modes of connection are known or may be hereinafter developed. A hard disk 752 is part of a fixed disk drive 751 which is connected to bus 730 by controller 750. It should be understood that other storage, peripheral, and computer processing means may be developed in the future, which may advantageously be used with the disclosure.

User input to computer system 700 may be provided by a number of devices. For example, a keyboard 756 and mouse 757 are connected to bus 730 by controller 755. An audio transducer 796, which may act as both a microphone and a speaker, is connected to bus 730 by audio controller 797, as illustrated. It will be obvious to those reasonably skilled in the art that other input devices, such as a pen and/or tablet, Personal Digital Assistant (PDA), mobile/cellular phone and other devices, may be connected to bus 730 and an appropriate controller and software, as required. DMA controller 760 is provided for performing direct memory access to RAM 710. A visual display is generated by video controller 765 which controls video display 770. Computer system 700 also includes a communications adapter 790 which allows the system to be interconnected to a local area network (LAN) or a wide area network (WAN), schematically illustrated by bus 791 and network 795.

Operation of computer system 700 is generally controlled and coordinated by operating system software, such as a Windows system, commercially available from Microsoft Corp., Redmond, Wash. The operating system controls allocation of system resources and performs tasks such as processing scheduling, memory management, networking, and I/O services, among other things. In particular, an operating system resident in system memory and running on CPU 705 coordinates the operation of the other elements of computer system 700. The present disclosure may be implemented with any number of commercially available operating systems.

One or more applications, such as an HTML page server, or a commercially available communication application, may execute under the control of the operating system, operable to convey information to a user.

What is claimed is:

1. A method, comprising:
using one or more processors executing software stored on computer readable storage medium to:
crawl through social media postings of one or more social media services to select postings relating to one or more sponsored events;
analyze text posted within the selected postings to quantify keywords relating to one or more brands; and
analyze images posted within the selected postings to quantify, using a pattern matching algorithm, depiction of the one or more brands within the images.

2. The method of claim 1, wherein crawling is carried out using an API of the one or more social media services.

3. The method of claim 1, wherein the images analyzed are frames within a video posted within the selected postings.

4. The method of claim 1, further including using the one or more processors to analyze videos posted within the selected postings to quantify, using a pattern matching algorithm, depiction of the one or more brands within frames of the videos.

5. The method of claim 1, further including using the one or more processors to use the quantified keywords and depictions to determine an extent of brand impressions of the one or more brands in association with sponsoring the one or more events.

6. The method of claim 1, wherein the one or more events include different events, and the quantified keywords and depictions are analyzed using Tradeoff Analytics of IBM Watson Technology to determine events for sponsorship of the one or more brands in the future.

7. The method of claim 6, wherein the Tradeoff Analytics compares an extent of brand impressions of the one or more brands at the one or more events for historical incidences of the one or more events.

8. The method of claim 1, wherein the keywords analyzed include one or more hashtags corresponding to the one or more brands.

9. The method of claim 1, further including analyzing text includes analyzing a sentiment of the text as being in favor of, or not in favor of, the one or more brands.

10. The method of claim 1, further including using the processor to compare the quantified keywords and depictions among historical incidences of the one or more events in order to determine a value of future sponsorship of the one or more brands for the one or more events.

11. The method of claim 1, wherein images are analyzed in postings where there are no keywords in the posting relating to the one or more brands.

12. The method of claim 1, wherein no sponsorship payment was made to include the images within the selected postings.

13. The method of claim 1, wherein the postings were posted to Twitter by people not affiliated with the one or more brands or the sponsor.

14. The method of claim 1, wherein the postings were posted to a social media service selected from the group consisting of TWITTER, FACEBOOK, INSTAGRAM, and YOUTUBE, by people not affiliated with the one or more brands or the sponsor.

15. The method of claim 1, wherein the one or more processors are further used to analyze sound files posted within the selected postings to identify, using an audio pattern matching algorithm, sounds corresponding to the one or more brands within the sound files.

16. The method of claim 1, wherein the one or more processors are further used to analyze text of news feed postings relating to the one or more sponsored events for text containing keywords relating to the one or more brands.

17. The method of claim 1, wherein the one or more processors executing software function as a service on the Internet.

18. A computer program product for evaluating an impact to a brand, comprising:
a computer readable storage medium having program instructions, embodied therewith, the program instructions executable by one or more processors to cause the one or more processors to:
crawl through social media postings of one or more social media services to select postings relating to one or more sponsored events;
analyze text posted within the selected postings to quantify keywords relating to one or more brands; and
analyze images posted within the selected postings to quantify, using a pattern matching algorithm, depiction of the one or more brands within the images.

19. A method for evaluating impact to a brand on social media, comprising:
using one or more processors executing software stored on computer readable storage medium to:
crawl through social media postings of one or more social media services to select social media user postings relating to one or more sponsored events using a predetermined list of events;
separate text, audio, video, and image data from the selected postings;
filter the separated data by one or more brands using a predetermined list of brands, by analyzing text to identify keywords within the separated data relating to one or more brands, and by analyzing images or video frames within the separated data to identify depictions of the one or more brands within the images; and
determine the social media impact of the one or more sponsored events by measuring an extent of the identified keywords and depictions in the social media postings relating to the one or more sponsored events.

20. The method of claim 19, further including using a remote tradeoff analytics service to use the measured extent of the identified keywords and depictions to inform a decision of a choice of events for sponsoring of the one or more brands in the future.
